(19) United States
(12) Patent Application Publication
(10) Pub. No.: US 2024/0024817 A1
(43) Pub. Date: Jan. 25, 2024

(54) USE OF CATALYST AND METHOD OF REMOVING ALDEHYDES

(71) Applicant: Dyson Technology Limited, Wiltshire (GB)

(72) Inventors: Dominic Peter VAN DER WAALS, Swindon (GB); Timothy Andrew JONES, Bath (GB); James Edward MILLS, Malmesbury (GB)

(73) Assignee: Dyson Technology Limited, Wiltshire (GB)

(21) Appl. No.: 18/265,469

(22) PCT Filed: Dec. 7, 2021
(86) PCT No.: PCT/GB2021/053190

§ 371 Date: Jun. 6, 2023

(30) Foreign Application Priority Data
Dec. 10, 2020 (GB) 2019515.2

(51) Int. Cl. B01D 53/86; B01D 53/96; B01J 23/34; B01J 37/00; B01J 38/02; B01J 21/02; B01J 38/12

(52) U.S. Cl. CPC B01D 53/8668; B01D 53/96; B01J 23/34; B01J 37/0018; B01J 38/02; B01J 21/02; B01J 38/12; B01D 2258/06; B01D 2257/7022; B01D 2257/708; B01D 2255/2073; B01D 2255/2022

(57) ABSTRACT

A method for removing one or more aldehydes from a carrier fluid, using a catalyst including manganese oxide. The method is particularly effective at removing longer chain aldehydes from a carrier fluid. Also provided is a method of regenerating a catalyst including manganese oxide.

### BACKGROUND OF THE INVENTION

The present disclosure relates to the removal of aldehydes from a fluid.

The present invention concerns the removal of aldehydes from a fluid. More particularly, but not exclusively, this invention concerns a method of removing one or more aldehydes from a fluid, such as a gas. The invention also concerns use of a catalyst comprising manganese oxide, which optionally comprises one or both of manganese IV oxide and cryptomelane, to remove one or more aldehydes from a fluid, such as a gas.

The present disclosure also relates to a method of regenerating a catalyst comprising manganese oxide.

In many countries, there are strict limits on the levels of certain airborne contaminants, such as volatile organic compounds (VOCs). Filters are often used to remove such compounds, and those filters may comprise a catalyst that facilitates the destruction of such compounds. An important category of such VOCs is aldehydes. Aldehydes are highly flammable and can cause eye, skin and respiratory irritation, and the removal of aldehydes from ambient air is desirable.

The present invention seeks to mitigate the above-mentioned problems. Alternatively or additionally, the present invention seeks to provide an improved method of removing one or more aldehydes from a fluid, such as a gas. Alternatively or additionally, the present invention seeks to provide an improved method of regenerating a catalyst, for example before or after use of the catalyst in a method of aldehyde removal.

### SUMMARY OF THE INVENTION

The present invention provides, according to a first aspect, a method of removing one or more aldehydes from a carrier fluid, the method comprising the step of:
contacting the carrier fluid comprising one or more aldehydes with a catalyst comprising manganese oxide.

The catalyst comprising manganese oxide is a catalyst that provides a source of manganese oxide. In some embodiments, the source of manganese oxide comprises a manganese oxide mineral. Preferably the catalyst comprises an oxide of manganese (IV). In preferred embodiments, the catalyst comprises manganese IV oxide and/or cryptomelane.

Surprisingly, it has been discovered that manganese oxide, particularly an oxide of manganese (IV), especially cryptomelane and/or manganese IV oxide, is effective at removing aldehydes, particularly aldehydes with more than one carbon atom, from a carrier fluid. Those skilled in the art will realise that the removal of one or more aldehydes comprises destruction of one or more aldehydes. In this connection, the catalyst catalyses the oxidation of one or more aldehydes, optionally to produce water and carbon dioxide.

The carrier fluid typically comprises an oxidant, such as oxygen. The catalyst catalyses the oxidation of one or more aldehydes.

As mentioned above, cryptomelane and manganese IV oxide have proved to be particularly effective at removing longer chain aldehydes from a carrier fluid. In this connection, the one or more aldehydes optionally comprises at least one aldehyde comprising at least two carbon atoms, optionally at least one aldehyde comprising at least three carbon atoms and optionally at least one aldehyde comprising at least four carbon atoms (such as butanal or crotanaldehyde). The applicant has surprisingly discovered that manganese oxide, particularly an oxide of manganese (IV), especially manganese IV oxide and/or cryptomelane, is effective at removing longer-chain aldehydes from a fluid stream.

The one or more aldehydes optionally comprises at least one aldehyde comprising up to six carbon atoms, optionally at least one aldehyde comprising up to 5 carbon atoms and optionally at least one aldehyde comprising up to 4 carbon atoms.

Optionally, the one or more aldehydes comprises no aldehydes comprising more than ten carbon atoms, optionally no aldehydes comprising more than eight carbon atoms, optionally no aldehydes comprising more than six carbon atoms and optionally no aldehydes comprising more than five carbon atoms.

The manganese oxide may be supported, i.e. the catalyst may comprise a support and the source of manganese oxide. In some embodiments, the catalyst comprises a support and manganese IV oxide and/or cryptomelane.

The term “support” refers to a material (e.g., a metal, semi-metal, semi-metal oxide, metal oxide, polymeric, ceramic, foam) onto or into which the source of manganese oxide (e.g. manganese IV oxide and/or cryptomelane) is located. The support may comprise a foam, for example. The support may comprise a ceramic support. The support may comprise a metal support, such as an aluminium support. The support may be a filter. The support may, for example, be an air filter, such as an air filter for a vehicle or a domestic air treatment device, such as a domestic air conditioning device.

The catalyst may comprise at least 10 wt % support, optionally at least 20 wt % support and optionally at least 30 wt % support. The catalyst may comprise up to 90 wt % support, optionally up to 80 wt % support and optionally up to 70 wt % support.

The catalyst may comprise at least 2 wt % source of manganese oxide, optionally at least source of manganese oxide, optionally at least 10 wt % source of manganese oxide, optionally at least 15 wt % source of manganese oxide and optionally at least 20 wt % source of manganese oxide. The catalyst may comprise up to 100 wt % source of manganese oxide, optionally up to 90 wt % source of manganese oxide, optionally up to 75 wt % source of manganese oxide, optionally up to 60 wt % source of manganese oxide, optionally up to 50 wt % source of manganese oxide, optionally up to 40 wt % source of manganese oxide, optionally up to source of manganese oxide and optionally up to 20 wt % source of manganese oxide.

The catalyst may comprise from 2 wt % to 30 wt % source of manganese oxide and optionally from 5 wt % to 20 wt % source of manganese oxide.

The catalyst may comprise at least 2 wt % manganese IV oxide and/or cryptomelane, optionally at least 5 wt % manganese IV oxide and/or cryptomelane, optionally at least 10 wt % manganese IV oxide and/or cryptomelane, optionally at least 15 wt % manganese IV oxide and/or cryptomelane and optionally at least 20 wt % manganese IV oxide and/or cryptomelane. The catalyst may comprise up to 100 wt % manganese IV oxide and/or cryptomelane, optionally up to 90 wt % manganese IV oxide and/or cryptomelane, optionally up to 75 wt % manganese IV oxide and/or cryptomelane, optionally up to 60 wt % manganese IV oxide and/or cryptomelane, optionally up to 50 wt % manganese IV oxide and/or cryptomelane, optionally up to 40 wt % manganese IV oxide and/or cryptomelane, optionally up to 30 wt % manganese IV oxide and/or cryptomelane and optionally up to 20 wt % manganese IV oxide and/or cryptomelane.

The catalyst may comprise from 2 wt % to 30 wt % manganese IV oxide and/or cryptomelane and optionally from 5 wt % to 20 wt % manganese IV oxide and/or cryptomelane.

The catalyst may comprise a binder. The binder may comprise alumina or a polymer, for example. The catalyst may comprise up to 60 wt % binder, optionally up to 50 wt % binder, optionally up to 40 wt % binder and optionally up to 30 wt % binder.

The source of manganese oxide (e.g. manganese IV oxide and/or cryptomelane) may optionally be unsupported.

The catalyst may comprise one or more catalytic additives. For example, the catalyst may comprise one or both of potassium and calcium.

The catalyst may be substantially free of catalytic additives.

The carrier fluid is preferably a gas, and preferably comprises air. As mentioned above, the catalyst catalyses the oxidation of one or more aldehydes, and air provides oxygen for the oxidation of one or more aldehydes. The carrier fluid optionally consists essentially of air. The carrier fluid optionally comprises, and optionally consists essentially of, ambient air, such as interior (indoor) ambient air or exterior (outdoor) ambient air.

The catalyst may, for example, be acidic or basic. The catalyst may have been treated with an acid or a base.

Surprisingly, it has been discovered that manganese oxide, particularly manganese IV oxide and/or cryptomelane, is effective at removing aldehydes from a carrier fluid at low temperatures, even if the concentration of the one or more aldehyde is low. The method may therefore comprise contacting the carrier fluid with the catalyst at a temperature of at least 10° C., optionally at least 15° C., optionally at least 20° C., optionally at least 25° C., optionally at least optionally at least 35° C. and optionally at least 40° C.

As mentioned above, manganese oxide, particularly manganese IV oxide and/or cryptomelane, is effective at removing aldehydes from a carrier fluid at low temperatures. The method may therefore comprise contacting the carrier fluid with the catalyst at a temperature of no more than 120° C., optionally no more than 110° C., optionally no more than 100° C., optionally no more than 90° C., optionally no more than 80° C., optionally no more than 70° C., optionally no more than 60° C. and optionally no more than 50° C.

The method may comprise contacting the carrier fluid with the catalyst at a temperature of from 10° C. to 120° C. and optionally from 20° C. to 100° C. Generally it has been found that higher temperatures lead to reduced rates of catalyst deactivation.

Those skilled in the art will realise that one or both of the carrier fluid and the catalyst may be heated and/or cooled. For example, the carrier fluid may be heated or cooled to the desired temperature, and contacted with the catalyst. Alternatively, the catalyst may be heated or cooled to the desired temperature.

Manganese oxide, particularly manganese IV oxide and/or cryptomelane, is an effective remover of aldehydes at low temperatures. In this connection, the method may comprise contacting the carrier fluid with the catalyst at a temperature of from 20° C. to 60° C., optionally from 20° C. to 50° C., optionally from 20° C. to 40° C. and optionally from 20° C. to 30° C.

While manganese oxide, particularly manganese IV oxide and cryptomelane, works unexpectedly well at low temperatures, like many such catalysts, it operates more effectively at higher temperatures. The method may therefore comprise contacting the carrier fluid with the catalyst at a temperature of from 40° C. to 120° C., optionally from 40° C. to 100° C. and optionally to 100° C.

The catalyst may consist essentially of a support and a source of manganese oxide, and optionally one or more binders. The support (and one or more binders, if present) may be substantially as described above.

The catalyst may consist essentially of a support and cryptomelane, and optionally one or more binders. The support (and one or more binders, if present) may be substantially as described above.

The catalyst may consist essentially of a support and manganese IV oxide, and optionally one or more binders. The support (and one or more binders, if present) may be substantially as described above.

The method may comprise contacting a flow of the carrier fluid with the catalyst. The flow rate of the carrier fluid may optionally be at least 10 L/min. per g of catalyst. The flow rate of the carrier fluid may be configured to provide a reduction in the aldehyde content of the carrier fluid of at least 30%, optionally of at least 40%, optionally of at least 50%, optionally of at least 60% and optionally of at least 70%.

The total time for which the carrier fluid is in contact with the catalyst, which is calculated as the total volume of catalyst divided by the flow rate of the treated fluid, is referred to as the residence time. Space velocity is the inverse of residence time. Unless otherwise stated, space velocity figures disclosed herein are GHSV (gas hourly space velocity). The space velocity is preferably at least 2 s⁻¹, more preferably at least 3 s⁻¹, and most preferably at least 4 s⁻¹. The space velocity is preferably at most 75 s⁻¹, more preferably at most 65 s⁻¹, and most preferably at most 56 s⁻¹.

In some embodiments, the space velocity is from 2 s⁻¹ to 75 s⁻¹. In some embodiments, the space velocity is from 3 s⁻¹ to 65 s⁻¹. In some embodiments, the space velocity is from 4 s⁻¹ to 56 s⁻¹. In some embodiments, the space velocity is from 6 s⁻¹ to 48 s⁻¹.

The carrier fluid may comprise at least 1 ppb one or more aldehydes, optionally at least one or more aldehydes, optionally at least 10 ppb one or more aldehydes, optionally at least one or more aldehydes and optionally at least 100 ppb one or more aldehydes. For the avoidance of doubt, the ppb levels mentioned herein are for the total of all aldehydes in the carrier fluid, unless the context of a statement dictates otherwise. For example, if the carrier fluid comprises 100 ppb propanal and 100 ppb butanal, the carrier fluid comprises 200 ppb one or more aldehydes.

The carrier fluid may comprise no more than 10,000 ppb one or more aldehydes, optionally no more than 8,000 ppb one or more aldehydes, optionally no more than 5,000 ppb one or more aldehydes, optionally no more than 3,000 ppb one or more aldehydes, optionally no more than 2,000 ppb one or more aldehydes and optionally no more than 1,000 ppb one or more aldehydes.

The carrier fluid may comprise from 1 ppb to 10,000 ppb one or more aldehydes, optionally from 10 ppb to 5,000 ppb one or more aldehydes, optionally from 50 ppb to 3,000 ppb one or more aldehydes and optionally from 100 ppb to 2,500 ppb aldehydes, optionally from 200 ppb to 2000 ppb, and optionally from 100 ppb to 200 ppb. The method of the present invention has been found to be particularly effective for removing relatively low levels of one or more aldehyde at low temperatures. In this connection, the method comprises contacting a carrier fluid comprising 100 ppb to 2500 ppb one or more aldehyde (optionally 100 ppb to 200 ppb) with the catalyst at a temperature of up to 100° C., optionally up to 80° C. and optionally up to 60° C., optionally at a temperature of from 20° C. to 60° C. and optionally at a temperature of from 35° C. to 60° C.

The carrier fluid may optionally be at ambient (atmospheric) pressure when contacted with the catalyst. The carrier fluid may optionally be at greater than ambient pressure when contacted with the catalyst, optionally at a pressure of from 101% to 125% or from 101% to 110% of ambient pressure when contacted with the catalyst. The carrier fluid may optionally be at less than ambient pressure when contacted with the catalyst, particularly if the carrier fluid comprises, or optionally consists essentially of, air (optionally ambient air). The carrier fluid may be at a pressure of from 80% to 99% of ambient pressure when contacted with the catalyst. Ambient pressure is the pressure of the surrounding medium, optionally the pressure of the surrounding air. The method may comprise passing the carrier fluid through a filter, optionally prior to contacting the carrier fluid with the catalyst (i.e. the filter is upstream of the catalyst). A compressor or fan may be used to draw the carrier fluid through a filter, into contact with the catalyst. The use of such a compressor or fan may facilitate the carrier fluid being at a pressure less than ambient pressure when it contacts the catalyst.

The method of the present invention may be considered to be a method of purifying the carrier fluid. The aldehyde content of the purified carrier fluid (i.e. the carrier fluid having passed through or over the catalyst) may be no more than 50% of the initial aldehyde content of the unpurified carrier fluid (the carrier fluid before having been passed through or over the catalyst), optionally no more than 40% of the aldehyde content of the unpurified carrier fluid, optionally no more than 30% of the aldehyde content of the unpurified carrier fluid, optionally no more than 20% of the aldehyde content of the unpurified carrier fluid and optionally more than 10% of the aldehyde content of the unpurified carrier fluid.

The catalyst may have high surface area. The catalyst may be monolithic. The catalyst may be porous. The catalyst may comprise tortuous flow paths, which cause turbulence and increase the frequency of collision of the aldehyde molecules with the catalyst.

Without wishing to be bound by theory, it is anticipated that contacting the one or more aldehydes with the catalyst causes the formation of water and carbon dioxide.

The step of contacting the carrier fluid with the catalyst may also remove ozone, if present, from the carrier fluid. Thus, a catalyst comprising manganese oxide, particularly manganese IV oxide and/or cryptomelane, is effective at removing ozone from a carrier fluid at low temperatures, even if the concentration of ozone is low. Therefore, in some embodiments, the carrier fluid comprises ozone. The temperatures and other features described herein for the step of contacting the carrier fluid with the catalyst are also applicable where ozone is being removed from the carrier fluid.

The method of the present invention may be performed by a domestic air treatment device.

It has been observed that different aldehyde functionality affects the aldehyde-removal reaction and the catalyst, especially the rate of deactivation of the catalyst. The step of contacting the carrier fluid may be varied in order to maximise the performance of the catalyst and/or to minimise the rate of deactivation of the catalyst. In some embodiments, the step of contacting the carrier fluid with the catalyst is variable in accordance with the one or more aldehydes comprised in the carrier fluid. In these embodiments, the one or more aldehydes in the carrier fluid are analysed by an analytical method (for example, using an electrochemical sensor, gas chromatography or mass spectrometry). The one or more aldehydes in the carrier fluid may be identified (for example, by molecular weight or functionality). The parameters and/or features of the step of contacting the carrier fluid may be subsequently controlled, such as the temperature, the flow rate, the residence time, the space velocity and/or the pressure.

In some embodiments, the method of the first aspect comprises:
(a) determining one or more physical or chemical properties of the one or more aldehydes within the carrier fluid and/or the concentration of each of the one or more aldehydes within the carrier fluid; and
(b) adjusting one or more parameters of the step of contacting the carrier fluid with the catalyst based on the determination out in step (a).

In some embodiments, step (a) comprises determining the molecular weight of the one or more aldehydes. In some embodiments, step (a) comprises determining the specific identities of the one or more aldehydes. In some embodiments, step (a) comprises the use of an analytical technique selected from an electrochemical sensor, gas chromatography and mass spectrometry, preferably an electrochemical sensor.

In some embodiments, the adjustment in step (b) comprises adjustment of one or more parameters selected from temperature, flow rate, residence time, space velocity and pressure. In some embodiments, the one or more parameters are adjusted to compensate for the effect of the one or more aldehydes on the deactivation of the catalyst. For example, it has been found that, in general, aldehydes of lower molecular weight (except formaldehyde) cause faster deactivation of the catalyst. Therefore, in some embodiments, the determination of aldehyde molecular weight in step (a) leads to an increase in the temperature in step (b) to offset the increased deactivation rate.

In some embodiments, the method of the present invention further comprises the step of facilitating removal from the carrier fluid of one or more impurities. This step is generally before the step of contacting with the catalyst as described above. The step of facilitating removal of impurities allows impurities in the carrier fluid to be removed, generally before one or more aldehydes are subsequently removed in the step of contacting the carrier fluid with the catalyst. This has the advantage of reducing deactivation of the catalyst, for example due to the removal of impurities that are chemical species capable of physisorption.

Preferably the one or more impurities are volatile organic compounds (VOCs). In some embodiments, the one or more impurities are selected from substituted or unsubstituted hydrocarbons having a molecular weight of up to 150 g mol⁻¹. In some embodiments, the one or more impurities are selected from substituted or unsubstituted aromatic hydrocarbons having a molecular weight of up to 150 g mol⁻¹. In some embodiments, the one or more impurities are selected from substituted or unsubstituted aliphatic and aromatic hydrocarbons having a molecular weight of up to 150 g mol⁻¹. In some embodiments, the one or more impurities are selected from hydrocarbons such as, but not limited to, benzene, toluene, xylene, ethylbenzene, styrene, propane, hexane, cyclohexane, aldehydes (such as, but not limited to, formaldehyde), limonene, pinene, ethyl acetate and butanol.

The step of facilitating removal of impurities may comprise filtering the carrier fluid. Preferably the filtering is performed by carbon filtering or by using an HEPA (high-efficiency particulate air) filter. Alternatively, the step of facilitating removal of impurities may comprise contacting the carrier fluid with a further catalytic species at room temperature, which may be particularly effective at removing formaldehyde, advantageously requiring no additional energy and leaving sites in the catalyst comprising manganese oxide available for longer-chain aldehyde removal in the step of contacting the carrier fluid with the catalyst comprising manganese oxide.

In alternative embodiments, the step of facilitating removal of impurities is after the step of contacting with the catalyst.

In some embodiments, the method of the first aspect further comprises the step of heating the catalyst to a regeneration temperature of at least 90° C. in the presence of a source of oxygen. Surprisingly, it has been discovered that the initial performance of a catalyst comprising manganese oxide, as described herein, can be fully recovered through a regeneration process, involving heating the catalyst to an elevated temperature (the regeneration temperature) in the presence of a source of oxygen. Generally higher regeneration temperatures lead to increased rates of catalyst performance recovery. Generally the total amount of catalyst performance recovered increases with regeneration time (i.e. the time of heating the catalyst to the regeneration temperature), up to a maximum efficiency. The step of heating the catalyst to the regeneration temperature may comprise heating the catalyst directly and/or heating the surroundings of the catalyst (such as the air or an airflow, which may comprise the source of oxygen). It is of course understood that the temperature of the catalyst will equilibrate with the temperature of the surroundings.

In some embodiments, the regeneration temperature is at least 100° C. In some embodiments, the regeneration temperature is at least 110° C. In some embodiments, the regeneration temperature is at least 120° C. In some embodiments, the regeneration temperature is at least 130° C. In some embodiments, the regeneration temperature is at least 140° C. In some embodiments, the regeneration temperature is at least 150° C. In some embodiments, the regeneration temperature is at least 160° C.

In some embodiments, the regeneration temperature is at most 300° C. In some embodiments, the regeneration temperature is at most 250° C. In some embodiments, the regeneration temperature is at most 225° C. In some embodiments, the regeneration temperature is at most 200° C. In some embodiments, the regeneration temperature is at most 175° C.

In some embodiments, the regeneration temperature is between 90° C. and 300° C. In some embodiments, the regeneration temperature is between 90° C. and 250° C. In some embodiments, the regeneration temperature is between 100° C. and 250° C. In some embodiments, the regeneration temperature is between 110° C. and 250° C. In some embodiments, the regeneration temperature is between 100° C. and 225° C. In some embodiments, the regeneration temperature is between 110° C. and 225° C. In some embodiments, the regeneration temperature is between 120° C. and 225° C. In some embodiments, the regeneration temperature is between 110° C. and 200° C. In some embodiments, the regeneration temperature is between 120° C. and 200° C. In some embodiments, the regeneration temperature is between 130° C. and 200° C. In some embodiments, the regeneration temperature is between 110° C. and 175° C. In some embodiments, the regeneration temperature is between 120° C. and 175° C. In some embodiments, the regeneration temperature is between 130° C. and 175° C.

In some embodiments, the step of heating the catalyst to the regeneration temperature comprises heating essentially the whole catalyst. In some embodiments, the step of heating the catalyst to the regeneration temperature comprises heating a fraction of the catalyst. In some embodiments, the step of heating the catalyst to the regeneration temperature comprises heating a first fraction of the catalyst, followed by one or more further fractions of the catalyst. The first fraction and the one or more further fractions of the catalyst may make up the whole, or essentially the whole, catalyst. The first fraction and the one or more further fractions of the catalyst may be heated separately and in turn. Each fraction of the catalyst may independently be less than three-quarters of the total mass of the catalyst, or less than half of the total mass of the catalyst, or less than a quarter of the total mass of the catalyst, or less than a sixth of the total mass of the catalyst, or less than a tenth of the total mass of the catalyst. In some embodiments, the step of heating the catalyst to the regeneration temperature comprises heating a fraction of the catalyst, followed by essentially the whole catalyst. In some embodiments, the step of heating the catalyst to the regeneration temperature comprises heating essentially the whole catalyst, followed by a fraction of the catalyst.

In some embodiments, the step of heating the catalyst to the regeneration temperature is carried out for at least 15 minutes. In some embodiments, the step of heating the catalyst to the regeneration temperature is carried out for at least 30 minutes. In some embodiments, the step of heating the catalyst to the regeneration temperature is carried out for at least 60 minutes. In some embodiments, the step of heating the catalyst to the regeneration temperature is carried out for at least 90 minutes. In some embodiments, the step of heating the catalyst to the regeneration temperature is carried out for at least 120 minutes. In some embodiments, the step of heating the catalyst to the regeneration temperature is carried out for at least 150 minutes.

In some embodiments, the step of heating the catalyst to the regeneration temperature is carried out for at most 12 hours. In some embodiments, the step of heating the catalyst to the regeneration temperature is carried out for at most 10 hours. In some embodiments, the step of heating the catalyst to the regeneration temperature is carried out for at most 8 hours. In some embodiments, the step of heating the catalyst to the regeneration temperature is carried out for at most 6 hours. In some embodiments, the step of heating the catalyst to the regeneration temperature is carried out for at most 4 hours.

In some embodiments, the step of heating the catalyst to the regeneration temperature is carried out for between 15 minutes and 12 hours. In some embodiments, the step of heating the catalyst to the regeneration temperature is carried out for between 30 minutes and 10 hours. In some embodiments, the step of heating the catalyst to the regeneration temperature is carried out for between 60 minutes and 8 hours. In some embodiments, the step of heating the catalyst to the regeneration temperature is carried out for between 90 minutes and 6 hours. In some embodiments, the step of heating the catalyst to the regeneration temperature is carried out for between 120 minutes and 6 hours. In some embodiments, the step of heating the catalyst to the regeneration temperature is carried out for between 90 minutes and 4 hours. In some embodiments, the step of heating the catalyst to the regeneration temperature is carried out for between 120 minutes and 4 hours. In some embodiments, the step of heating the catalyst to the regeneration temperature is carried out for between 150 minutes and 6 hours. In some embodiments, the step of heating the catalyst to the regeneration temperature is carried out for between 150 minutes and 4 hours.

The step of heating the catalyst to the regeneration temperature may be before or after the step of contacting the carrier fluid with the catalyst. Preferably, the step of heating the catalyst to the regeneration temperature is before the step of contacting the carrier fluid with the catalyst.

In some embodiments, the method comprises the step of facilitating removal of impurities, as described above, in addition to the step of heating the catalyst to the regeneration temperature and the step of contacting the carrier fluid with the catalyst.

In some embodiments, the method comprises the step of heating the catalyst to the regeneration temperature, followed by the step of contacting the carrier fluid with the catalyst, followed by a further step of heating the catalyst to the regeneration temperature. Such a method may also optionally comprise the step of facilitating removal of impurities, as described herein, preferably before the step of contacting the carrier fluid with the catalyst.

In some embodiments, the length of time of carrying out the step of contacting with the catalyst is at most 50 times the length of time of the step of heating the catalyst to the regeneration temperature. In some embodiments, the length of time of carrying out the step of contacting with the catalyst is at most 40 times the length of time of the step of heating the catalyst to the regeneration temperature. In some embodiments, the length of time of carrying out the step of contacting with the catalyst is at most 30 times the length of time of the step of heating the catalyst to the regeneration temperature. In some embodiments, the length of time of carrying out the step of contacting with the catalyst is at most 20 times the length of time of the step of heating the catalyst to the regeneration temperature. In some embodiments, the length of time of carrying out the step of contacting with the catalyst is at most 10 times the length of time of the step of heating the catalyst to the regeneration temperature.

In some embodiments, the length of time of carrying out the step of contacting with the catalyst is at least 2 times the length of time of the step of heating the catalyst to the regeneration temperature. In some embodiments, the length of time of carrying out the step of contacting with the catalyst is at least 3 times the length of time of the step of heating the catalyst to the regeneration temperature.

In some embodiments, the length of time of carrying out the step of contacting with the catalyst is between 2 times and 50 times the length of time of the step of heating the catalyst to the regeneration temperature. In some embodiments, the length of time of carrying out the step of contacting with the catalyst is between 2 times and 40 times the length of time of the step of heating the catalyst to the regeneration temperature. In some embodiments, the length of time of carrying out the step of contacting with the catalyst is between 2 times and 30 times the length of time of the step of heating the catalyst to the regeneration temperature. In some embodiments, the length of time of carrying out the step of contacting with the catalyst is between 2 times and 20 times the length of time of the step of heating the catalyst to the regeneration temperature. In some embodiments, the length of time of carrying out the step of contacting with the catalyst is between 2 times and 10 times the length of time of the step of heating the catalyst to the regeneration temperature. In some embodiments, the length of time of carrying out the step of contacting with the catalyst is between 3 times and 50 times the length of time of the step of heating the catalyst to the regeneration temperature. In some embodiments, the length of time of carrying out the step of contacting with the catalyst is between 3 times and 40 times the length of time of the step of heating the catalyst to the regeneration temperature. In some embodiments, the length of time of carrying out the step of contacting with the catalyst is between 3 times and times the length of time of the step of heating the catalyst to the regeneration temperature. In some embodiments, the length of time of carrying out the step of contacting with the catalyst is between 3 times and 20 times the length of time of the step of heating the catalyst to the regeneration temperature. In some embodiments, the length of time of carrying out the step of contacting with the catalyst is between 3 times and 10 times the length of time of the step of heating the catalyst to the regeneration temperature.

As disclosed above, it has been observed that different aldehyde functionality affects the aldehyde-removal reaction and the catalyst, especially the rate of deactivation of the catalyst. In some embodiments, the step of heating the catalyst to the regeneration temperature is variable in accordance with the one or more aldehydes comprised in the carrier fluid. In these embodiments, the one or more aldehydes in the carrier fluid are analysed by an analytical method (for example, using an electrochemical sensor, gas chromatography or mass spectrometry). The one or more aldehydes in the carrier fluid may be identified (for example, by molecular weight or functionality). Following deactivation of the catalyst in the step of contacting the carrier fluid with the catalyst, the parameters and/or features of the step of heating the catalyst to the regeneration temperature may be controlled, such as the regeneration temperature, the regeneration time and/or the pressure. This control allows the rate of regeneration to be tailored and/or maximised.

In some embodiments, the method comprises:
(i) determining one or more physical or chemical properties of the one or more aldehydes within the carrier fluid and/or the concentration of each of the one or more aldehydes within the carrier fluid; and
(ii) adjusting one or more parameters of the step of heating the catalyst to a regeneration temperature, based on the determination carried out in step (i).

In some embodiments, step (i) comprises determining the molecular weight of the one or more aldehydes. In some embodiments, step (i) comprises determining the specific identities of the one or more aldehydes. In some embodiments, step (i) comprises the use of an analytical technique selected from an electrochemical sensor, gas chromatography and mass spectrometry, preferably an electrochemical sensor.

In some embodiments, the adjustment in step (ii) comprises adjustment of the regeneration temperature. In some embodiments, the regeneration temperature is adjusted to compensate for the effect of the one or more aldehydes on the deactivation of the catalyst. For example, it has been found that, in general, aldehydes of lower molecular weight cause faster deactivation of the catalyst. Therefore, in some embodiments, the determination of aldehyde molecular weight in step (i) leads to an increase in the regeneration temperature in step (ii) to offset the increased deactivation.

According to a second aspect of the invention there is also provided a method of regenerating a catalyst, comprising the step of heating the catalyst to a regeneration temperature of at least 90° C. in the presence of a source of oxygen. The features of this step described herein in relation to the first aspect apply mutatis mutandis to the second aspect. For example, the catalyst is defined in accordance with the definition of the catalyst in the method of the first aspect of the present invention (i.e. the catalyst comprises manganese oxide and may have one or more of the features described above), and at least the regeneration temperatures and times as described above also apply to the second aspect. In other words, the step of heating the catalyst to the regeneration temperature may either be encompassed by the first aspect of the invention, or be a step in a distinct aspect of the invention (i.e. in the second aspect, relating to a method of regenerating a catalyst).

According to a third aspect of the invention there is also provided use of a catalyst comprising manganese oxide to remove one or more aldehydes from a carrier fluid. As mentioned above in relation to the method of the first aspect of the present invention, the catalyst comprising manganese oxide is a catalyst that provides a source of manganese oxide. In some embodiments, the source of manganese oxide comprises a manganese oxide mineral. Preferably the catalyst comprises manganese IV. In preferred embodiments, the catalyst comprises manganese IV oxide and/or cryptomelane. The method of the third aspect of the present invention may comprise use of a catalyst comprising manganese oxide, preferably manganese IV oxide and/or cryptomelane, to destroy one or more aldehydes carried in a carrier fluid.

The use of the third aspect of the present invention may comprise those features described above in relation to the method of the first aspect of the present invention. For example, the one or more aldehydes may have one or more of the features described above in relation to the method of the first aspect of the present invention. The carrier fluid may have one or more of the features described above in relation to the method of the first aspect of the present invention.

In accordance with a fourth aspect of the present invention, there is provided a catalyst for use in the method of the first aspect of the present invention and/or the method of the second aspect of the present invention and/or the use of the third aspect of the present invention.

The catalyst may have one or more of the features described above in relation to the method of the first aspect of the present invention.

In accordance with a fifth aspect of the present invention, there is provided a domestic air treatment device comprising a catalyst in accordance with the fourth aspect of the present invention.

The catalyst may comprise one or more of the features described above in relation to the method of the first aspect of the present invention. The domestic air treatment device of the fifth aspect of the present invention may be used to remove one or more aldehydes from a carrier fluid and/or to regenerate the catalyst. The domestic air treatment device of the fifth aspect of the present invention may therefore be operated in a method in accordance with the first aspect and/or the second aspect of the present invention.

It will of course be appreciated that features described in relation to one aspect of the present invention may be incorporated into other aspects of the present invention. For example, the method of the invention may incorporate any of the features described with reference to the apparatus of the invention and vice versa.

### SUMMARY OF THE FIGURES

Embodiments and experiments illustrating the principles of the invention will now be discussed with reference to the accompanying figures.

FIG. 1. Graph showing single pass efficiency (SPE) over time from test data obtained during extended Continuous Injection Analysis (CIA) testing.

FIG. 2. Graph showing the decrease in SPE over the course of extended SPE tests and different temperatures.

FIG. 3. Graph showing SPE against cumulative test time for different catalyst temperatures during CIA testing.

FIG. 4. Graph showing the change in SPE for cryptomelane on aluminium as measured in an SPE test for different acetaldehyde concentrations.

FIG. 5. Graphs showing initial SPE (graph A) and SPE after exposure to approximately 36 hours of airflow (graph B) of 7 cryptomelane on aluminium samples.

FIG. 6. Graph showing the concentration of acetaldehyde measured downstream from a catalyst over time after purging with clean air.

FIG. 7. Graph showing the decrease in SPE over cumulative test time and subsequent recovery in SPE following regeneration.

FIG. 8. Graph showing the SPE measured before regeneration, and the SPE following regeneration at various temperatures.

FIG. 9. Graph showing the relationship between total catalyst performance recovery and regeneration temperature.

FIG. 10. Graph showing the relationship between total catalyst performance recovery and regeneration time.

FIG. 11. Graph showing the difference in SPE between initial and post-deactivation and subsequent regeneration, over cumulative regeneration time.

FIG. 12. Graph showing the relationship between SPE and space velocity.

### DETAILED DESCRIPTION

Embodiments of the present invention will now be described by way of example only, with reference to the accompanying figures.

### Examples 1-3 and Comparative Examples 1-3

The ability of cryptomelane to remove aldehydes from a stream of air was investigated. A gas comprising acetaldehyde, propanal, butanal, crotonaldehyde, isopropyl alcohol, acetone and methyl acetate in air was passed through 50 g of catalyst (BASF SE) comprising cryptomelane mounted on a metal support. The estimated cryptomelane content is 5-20 wt % of the weight of the catalyst. Samples of gas having passed through the cryptomelane were analysed as a function of time using a gas chromatography mass spectrometer, and the results are shown in Table 1. The temperature was 90° C., and the concentration of each of acetaldehyde, propanal, butanal, crotonaldehyde, isopropyl alcohol, acetone and methyl acetate was 0.5 ppm. The flow rate was 7.5 litres/second, with 39.1/s GHSV (gas hourly space velocity).

TABLE 1
challenge agents passing through cryptomelane catalyst

| | Height of GCMS peak (% passing through catalyst, ±3%) | | | | | |
|---|---|---|---|---|---|---|
| | | | | Comparative | | Comparative |
| | | | | Example 1 | Comparative | Example 3 |
| Time | Example 1 | Example 2 | Example 3 | Isopropyl | Example 2 | Methyl |
| (mins) | Propanal | Butanal | Crotanaldehyde | alcohol | Acetone | acetate |
| 0 | 18 | 60 | 55 | 12 | 90 | 90 |
| 15 | 6 | 12 | 12 | 20 | 100 | 90 |
| 30 | 2 | 3 | 2 | 8 | 60 | 90 |
| 45 | 1 | 0 | 2 | 3 | 50 | 90 |

The data of Table 1 show that, surprisingly, cryptomelane is particularly effective at removing aldehydes from a carrier gas (in this case, aldehydes comprising three and four carbon atoms) at relatively low temperatures, but was far less effective at removing a variety of other challenges, such as alcohols (e.g. isopropyl alcohol), ketones (e.g. acetone) and esters (methyl acetate).

### Example 4

The ability of manganese IV oxide to remove aldehydes from a stream of air at about 100° C. was also investigated. A flow of air (251/min) comprising 0.5 ppm acetaldehyde was passed over 0.5 g of 60-mesh manganese IV oxide (Sigma Aldrich) at about 100° C. initial temperature, and the concentration of acetaldehyde in the air was measured. It is estimated that the temperature of the catalyst during measurement. In the absence of the catalyst, the concentration of acetaldehyde was determined to be 0.53 ppm. Immediately after insertion of the catalyst, the concentration of acetaldehyde in the air that had been passed through the catalyst was 0.20 ppm, rising slightly over a period of about 1 hour to a steady level of about 0.30 ppm. After removal of the catalyst, the concentration of the acetaldehyde in the airflow was determined to be about 0.48 ppm.

This demonstrates that manganese IV oxide is particularly effective at removing aldehydes (in particular, acetaldehyde) from a stream of air at relatively low temperatures.

### Comparative Examples 4-9

The method of Example 4 was repeated using different prospective catalysts, in this case manganese II oxide (Comparative Example 4), manganese II, III oxide (Comparative Example 5) Li₂Mn₂O₄ (Comparative Example 6) and Fe₂O₃ (Comparative Example 7). None of the catalysts of Comparative Examples 4-7 worked effectively under the conditions of Example 4. The method of Example 4 was also repeated using manganese III oxide (Comparative Example 8), at a lower temperature of 60° C., but this showed limited to no removal of acetaldehyde. Catalysts comprising Pd or Pt (Comparative Example 9) were also investigated for their ability to remove acetaldehyde, but temperatures much higher than 100° C. were needed for effective removal of acetaldehyde and did not yield high single pass efficiencies, gram-for-gram.

### Examples 5-8

Single pass efficiency (SPE) is a performance metric that indicates the amount of challenge pollutant removed from the treated fluid in a single pass through the catalyst. SPE testing is a type of testing that involves passing a constant concentration of pollutant through a catalyst sample and measuring the difference in pollutant concentration upstream and downstream of the catalyst.

The ability of cryptomelane to remove various concentrations of acetaldehyde from an air flow was investigated as a function of temperature. 15 g of catalyst comprising cryptomelane supported on aluminium (BASF SE) was subjected to a challenge of acetaldehyde at 0.2 ppm (Example 5), 0.3 ppm (Example 6), 0.4 ppm (Example 7) and 0.5 ppm (Example 8) (flow rate was 25 litres/minute, 33.9/s space velocity). The single pass efficiency (SPE) was measured as a function of temperature at each stated concentration of acetaldehyde, and it was found that cryptomelane is a surprisingly effective catalyst for removing aldehydes (in this case, acetaldehyde), even at very low temperatures (e.g. 30° C.). Moreover, at slightly elevated temperatures (e.g. 70° C.), cryptomelane is a very efficient catalyst for removing aldehydes from an airflow. Furthermore, for these conditions at least, it was found that the efficiency of the catalyst was independent of the concentration of the challenge.

### Examples 9-11

The ability of cryptomelane to remove acetaldehyde, propanal and crotanaldehyde from an air flow was investigated as a function of temperature. 33.6 g of a catalyst comprising cryptomelane supported on aluminium was subjected to a challenge of acetaldehyde at 0.5 ppm (Example 11), propanal at 0.5 ppm (Example 9) and crotanaldehyde at 0.5 ppm (Example 10) (flow rate of 7.5 litres/second, 39.1/s GHSV). The single pass efficiency for acetaldehyde was 14% at 50° C. and 28% at 70° C. The single pass efficiency for propanal was 14% at 50° C. and 28% at 70° C. The single pass efficiency for crotanaldehyde was 25% at 50° C. and 29% at 70° C. Examples 9 and 10 demonstrate that cryptomelane is surprisingly effective at removing longer chain aldehydes, such as propanal and crotanaldehyde, from an air flow, even at relatively low temperatures.

### Example 12

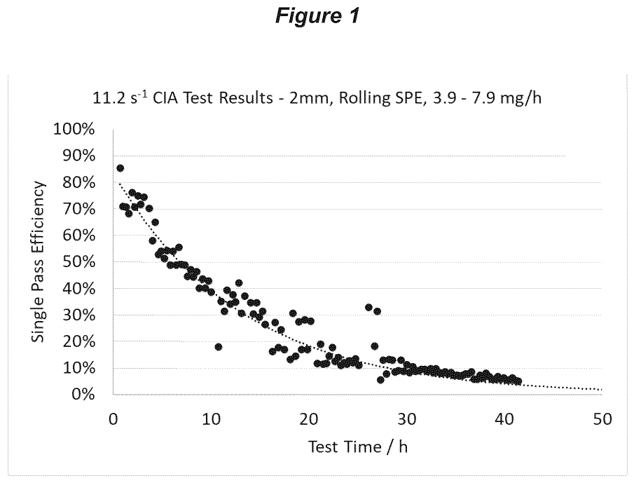

FIG. 1 displays Example 12, namely test data obtained during extended Continuous Injection Analysis (CIA) testing. CIA testing is a type of testing that involves continuously dosing a chamber with pollutant at a set mass dosage rate whilst a catalyst sample is used to clean the chamber. The chamber is continuously mixed and the concentration of pollutant in the chamber is logged. From the concentration measurements, flow rate through the catalyst and the pollutant mass dosage rate, the SPE can be determined.

In Example 12, the CIA testing was conducted within a 30 m 3 chamber, using acetaldehyde as the pollutant with cryptomelane on an aluminium support (BASF SE, as is the case in all examples using this catalyst). The catalyst had a pore diameter of 2 mm. The mass dosage rate of the pollutant was 3.9-7.9 mg/h (the initial mass dosage rate was 7.9 mg/h, which was reduced for subsequent tests to ensure that the concentration within the chamber did not increase excessively due to the reduction in SPE). The airflow was heated to 50° C. The space velocity was 11.2 s⁻¹. FIG. 1 shows multiple tests combined with the x-axis being the cumulative test time. The data showed a decrease in SPE over the exposure time, from approximately between 86% and 70% within the first hour to about 5% after 42 hours. This demonstrated that the performance of the catalyst decreases as the cumulative exposure time to both the aldehyde and airflow increases.

### Examples 13-16

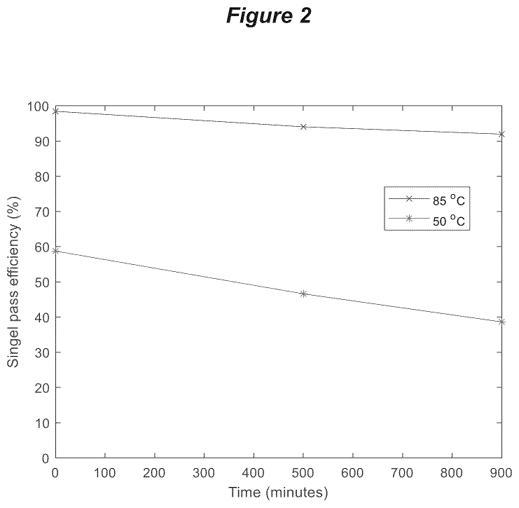

The temperature dependency of catalyst deactivation was also investigated. FIG. 2 displays the change in SPE over time for cryptomelane on aluminium catalyst samples (having a pore diameter of 1 mm), which were exposed to 0.5 ppm of acetaldehyde at 50° C. (Example 13) and 85° C. (Example 14) in otherwise identical SPE tests, in which the space velocity was 14.7 s⁻¹. The heating took place in an oven, such that both the airflow and the catalyst were heated to the respective temperature. Over 15 hours, at 50° C. the SPE decreased by 20.1%, while at 85° C. the SPE decreased by 6.5%.

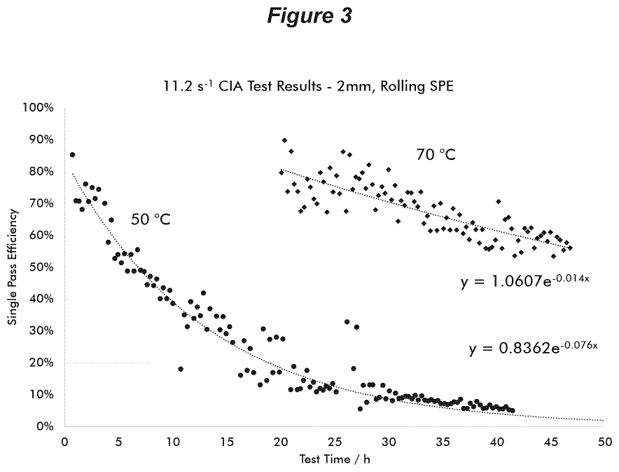

FIG. 3 displays SPE against cumulative test time for different catalyst temperatures during CIA testing. The CIA tests used acetaldehyde as the pollutant and cryptomelane on aluminium catalyst samples (having a pore diameter of 2 mm), and these tests were identical other than the airflow temperature. The space velocity was 11.2 s⁻¹. At 50° C. (Example 15), the rate of deactivation was found to be approximately 5.4 times greater than at 70° C. (Example 16).

Therefore Examples 13 to 16 demonstrated that the rate of deactivation of the catalyst decreases as the temperature of the catalyst increases.

### Examples 17-20

The variation in catalyst deactivation for different aldehydes was investigated. Table 2 displays the results from a set of CIA tests, which were identical other than the identity of the challenge pollutant. Initial SPE values and SPE decay rates are shown for the different aldehydes, where k refers to the exponential decay rate constant fitted through the measured SPE data with time from CIA tests at approximately 3.7 mg/h injection rate.

TABLE 2
Initial SPE values and SPE decay rates
for different aldehydes by CIA testing

| | Example 17 | Example 18 | Example 19 | Example 20 |
|---|---|---|---|---|
| | Crotonaldehyde | Butanal | Propanal | Acetaldehyde |
| SPE decay | −0.0123 h⁻¹ | −0.0094 h⁻¹ | −0.0212 h⁻¹ | −0.032 h⁻¹ |
| rate (k) | | | | |
| Initial SPE | 100% | 100% | 90% | 80% |

It was observed that the rate of catalyst deactivation varies with different aldehyde functionality, where the variation is in line with initial performance. Generally, lower aldehyde molecular weight leads to an increased rate of deactivation (although it is expected that formaldehyde would not follow this trend under these conditions).

### Examples 21-23

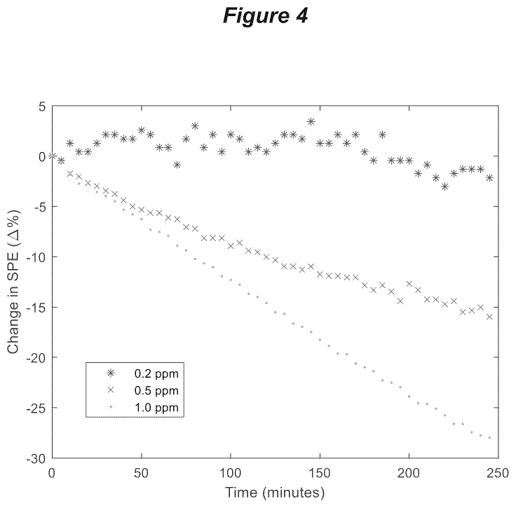

The effect of aldehyde concentration on deactivation rate was investigated. FIG. 4 shows the change in SPE for cryptomelane on aluminium as measured in an SPE test for different acetaldehyde concentrations, where the data are offset to show the change in SPE from the initial value. The acetaldehyde concentrations tested were 1.0 ppm (Example 21), 0.5 ppm (Example 22) and 0.2 ppm (Example 23). These tests were conducted on the same sample at 50° C. with regenerations conducted between each test. It was observed that there was a decrease in SPE from the initial SPE over time, and that the rate of deactivation increases with increased concentration of the aldehyde challenge pollutant.

### Example 24

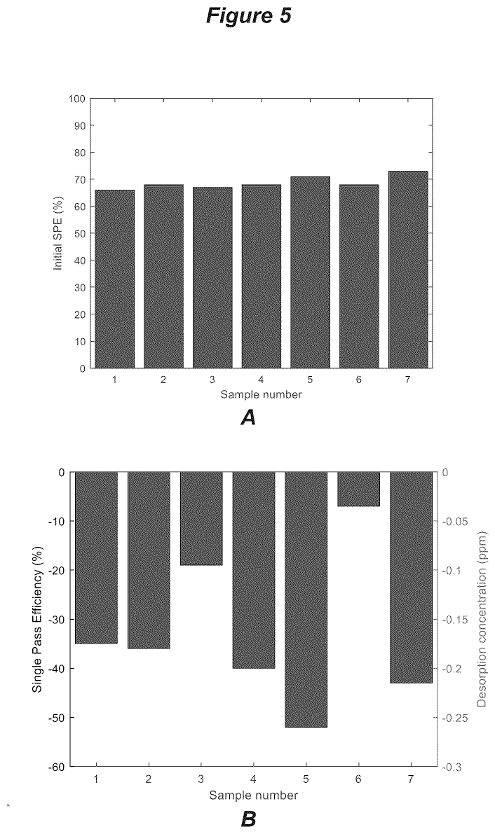

Seven samples of cryptomelane on aluminium (sample numbers 1 to 7) were deactivated using separate airflows for approximately 36 hours. The SPE was measured before and after deactivation at a temperature of 57° C. FIG. 5 displays the observations of Example 24, where graph A shows the initial SPE and graph B shows the SPE after exposure to the approx. 36 hours of airflow, for each of sample numbers 1 to 7.

A negative SPE in this case indicates that off-gassing/desorption is occurring, i.e. a higher sensor signal is measured downstream from the catalyst than upstream whilst the challenge pollutant is passed through the entire test system. The off-gassing concentration is shown on the right axis of graph B, which is based on a calibration using acetaldehyde. For all SPE tests an Alphasense PID sensor was used. As the response factor of PID sensors can vary significantly for different VOCs, the concentration shown is an approximation.

The results showed that deactivation also occurs due to exposure to VOCs in the air. Heating catalyst samples, which have been exposed to airflow for an extended period, results in VOCs being off-gassed from the catalyst. The off-gassing measured shows that deactivation due to airflow and other VOCs is due to physisorption. As such, removing VOCs by a method such as pre-filtering (e.g. carbon filtering) would reduce deactivation effects.

### Example 25

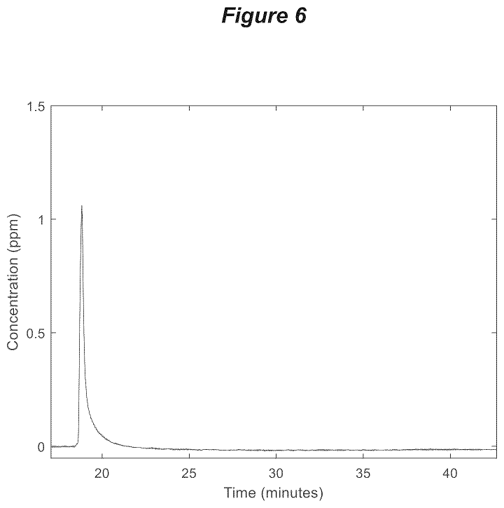

Catalyst samples were exposed to 0.5 ppm acetaldehyde for approximately 16 hours at 60° C. in an SPE test, during which the SPE was continuously measured. The total mass of acetaldehyde that was removed by the catalyst was then calculated. The catalyst sample was subsequently regenerated within a sealed chamber. This chamber was then purged with clean air whilst the concentration was measured downstream. From this, the mass of any off-gassed/desorbed acetaldehyde was calculated (see FIG. 6, which shows the concentration of acetaldehyde measured downstream from a cryptomelane on aluminium catalyst after purging with clean air). Table 3 shows the percentage of acetaldehyde that was destroyed for different catalysts. Deactivation due to aldehydes is related to a saturated catalytic cycle.

TABLE 3
Percentage of acetaldehyde destroyed

| | | Post- | Post- | Mass | Mass | |
|---|---|---|---|---|---|---|
| | Initial | deactivation | regeneration | removed in | desorbed in | Percentage |
| Material | SPE | SPE | SPE | regeneration | regeneration | destroyed |
| MnO₂ | 60% | 4% | 57% | 1.39 mg | 0.01 mg | >99% |
| powder | | | | | | |
| Cryptomelane | 77% | 64% | 84% | 6.37 mg | 0.02 mg | >99% |
| on Al | | | | | | |

### Examples 26-30

It has been discovered that initial catalyst performance can be fully recovered through a regeneration process, involving heating the catalyst to an elevated temperature in the presence of a source of oxygen. In the following examples and associated figures, “regeneration” can also be referred to as “reactivation”.

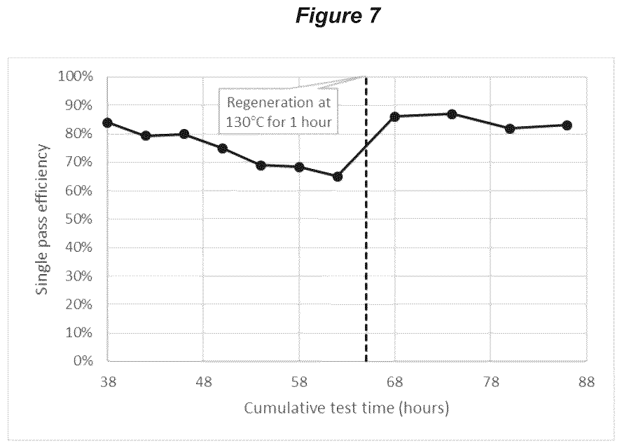

In Example 26, a test chamber was repeatedly dosed with a set mass of pollutant (crotonaldehyde), while a catalyst sample (cryptomelane on aluminium) was used to clean the chamber at a temperature of 60° C. The catalyst had a pore diameter of 1 mm, and the space velocity was 10.15 s⁻¹. The effect of heating the catalyst to 130° C. for 1 hour was observed. The rate of change of pollutant concentration in the chamber was used to calculate the removal efficiency of the catalyst, accounting for the flow rate of the test. FIG. 7 shows the results of Example 26. Each data point represents the performance measured from each dose of the pollutant. With each successive test, the cumulative test time increases as the catalyst processes more pollutant. A representative illustration of the effect of heating a catalyst is displayed in FIG. 7, which shows the decrease in SPE over cumulative test time and a subsequent recovery in SPE following regeneration.

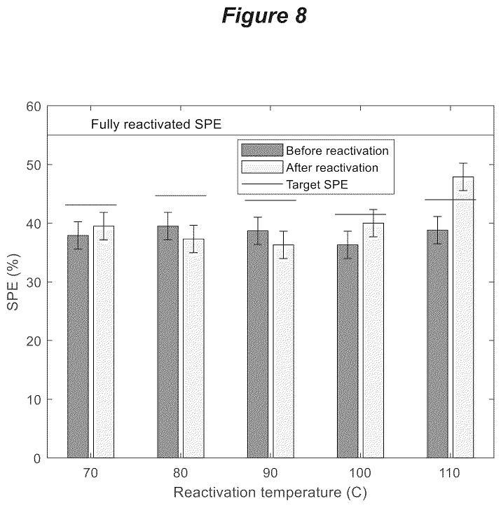

In Example 27, a single sample of cryptomelane on aluminium was deactivated (by 16 hours of airflow within a laboratory environment) and subsequently regeneration was attempted by heating for 60 minutes. The heating was performed at various temperatures between 70° C. and 110° C. The SPE was measured before and after heating. The results are shown in FIG. 8.

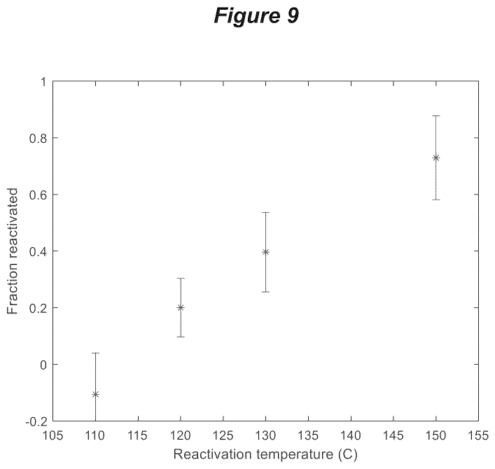

In Example 28, the relationship between the total catalyst performance recovery and regeneration temperature was observed. The same test set-up as that in Example 27 was used except that, in Example 28, each regeneration was conducted on the same sample for 15 minutes at various temperatures between 110° C. and 150° C. The results are shown in FIG. 9, in which a value of 1 on the axis of “Fraction reactivated” would be equal to complete recovery of performance. The rate of performance recovery was found to increase with regeneration temperature.

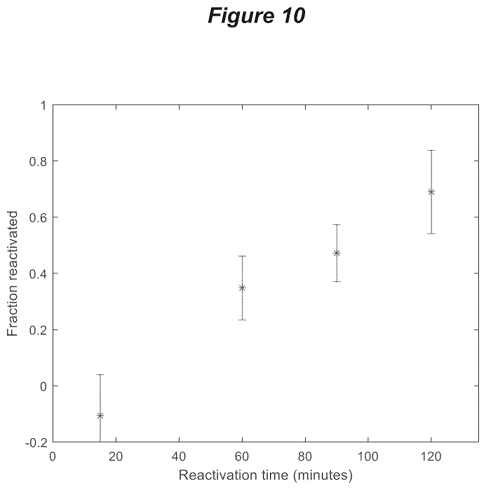

In Example 29, the relationship between the total catalyst performance recovery and regeneration time was observed. The same test set-up as that in Example 27 was used except that, in Example 29, regeneration was conducted on the same sample at 110° C. for varying lengths of time. The results are shown in FIG. 10, in which a value of 1 on the axis of “Fraction reactivated” would be equal to complete recovery of performance. The total amount of catalyst performance recovered was found to increase with regeneration time (i.e. the time of heating the catalyst to the regeneration temperature), up to a maximum efficiency.

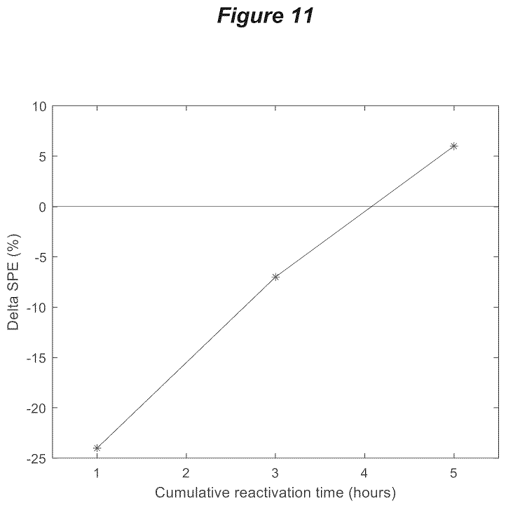

The relationship between the total catalyst performance recovery and regeneration time was also observed in Example 30. This used a similar set-up to that in Example 24, in which a sample of cryptomelane on aluminium was deactivated using airflow for approximately 36 hours in a home. The SPE was measured before and after deactivation at a temperature of 57° C. Subsequently, regeneration was attempted by heating at 130° C. for 1 hour, a further 2 hours, and a further 2 hours again, with SPE tests conducted between each regeneration. The results are shown in FIG. 11, which shows the difference in SPE between initial and post-deactivation and subsequent regeneration, over cumulative regeneration time. It can be seen that a significantly longer period of time was required to regenerate this sample, compared with Example 27 (FIG. 8) which involved a shorter deactivation time. Therefore the total time required to recover initial catalyst performance is dependent on the total performance loss.

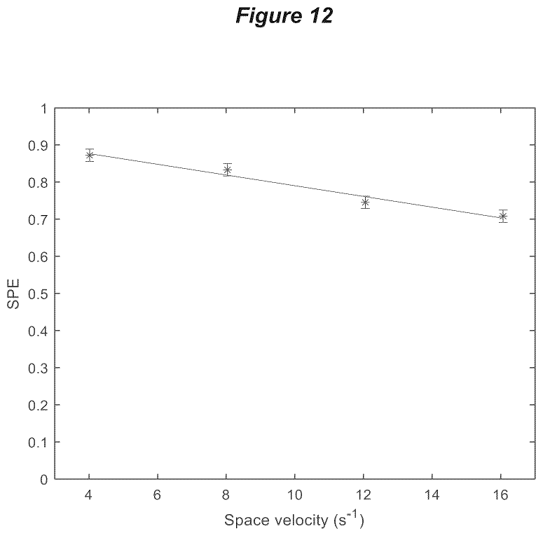

In further experiments, it has also been observed that SPE is related to residence time and space velocity. Residence time is the total time for which treated fluid is in contact with the catalyst, which is calculated as the total volume of catalyst divided by the flow rate of the treated fluid. Space velocity is the inverse of residence time. Data showing the relationship between SPE and space velocity are shown in FIG. 12. FIG. 12 shows four separate SPE experiments conducted on a single catalyst sample (having a pore diameter of 2 mm and a volume of 20 cm³). The sample was regenerated between tests and the flow rate was varied to achieve the different space velocities. The SPE tests were all conducted at 50° C.

### Comparative Example 10

The effect of an absence of oxygen during attempted regeneration on the total catalyst performance recovery was observed. A cryptomelane on aluminium catalyst was exposed to zero air and 2.73 ppm acetaldehyde for about 16 hours, and then regenerated at 130° C. in a sealed chamber filled with nitrogen for 2 hours. The SPE was measured before and after deactivation and then again after regeneration in nitrogen. The results are shown in Table 4. It can be seen that there was no appreciable regeneration observed in the nitrogen atmosphere, demonstrating a need for a source of oxygen in the regeneration process.

TABLE 4
Regeneration of deactivation caused by
aldehydes requires a source of oxygen

| Test | Single pass efficiency (SPE) |
|---|---|
| Before deactivation | 84% |
| After deactivation in zero air | 72% |
| and 2.73 ppm acetaldehyde | |
| After 2 hours at 130° C. in N₂ | 73% |

Whilst the present invention has been described and illustrated with reference to particular embodiments, it will be appreciated by those of ordinary skill in the art that the invention lends itself to many different variations not specifically illustrated herein. By way of example only, certain possible variations will now be described.

The examples above demonstrate the use of one particular type of manganese IV oxide. Those skilled in the art will realise that other manganese IV oxides (i.e. other oxides of manganese (IV)) may be used.

The examples above demonstrate the use of unsupported manganese IV oxide. Those skilled in the art will realise that it is possible for the manganese IV oxide to be on a support.

The examples above demonstrate the use of cryptomelane on a support, such as on a foam or metal support. Those skilled in the art will realise that other supports are possible, and that cryptomelane may be used unsupported.

The examples above demonstrate how manganese IV oxide and cryptomelane may be used to remove aldehydes having up to four carbon atoms. Those skilled in the art will realise that manganese IV oxide and cryptomelane may be used to remove aldehydes with more than four carbon atoms.

The examples above show how manganese IV oxide and cryptomelane may be used by themselves to remove aldehydes from a carrier fluid. Those skilled in the art will realise that it would be possible to use manganese IV oxide and cryptomelane with other catalyst components. For example, manganese IV oxide and cryptomelane may be used together, for example, with both manganese IV oxide and cryptomelane on the same support. Alternatively or additionally, manganese IV oxide may be used sequentially with cryptomelane, for example, by first contacting carrier fluid with, say, manganese IV oxide, and then contacting the carrier fluid with cryptomelane.

Where in the foregoing description, integers or elements are mentioned which have known, obvious or foreseeable equivalents, then such equivalents are herein incorporated as if individually set forth. Reference should be made to the claims for determining the true scope of the present invention, which should be construed so as to encompass any such equivalents. It will also be appreciated by the reader that integers or features of the invention that are described as preferable, advantageous, convenient or the like are optional and do not limit the scope of the independent claims. Moreover, it is to be understood that such optional integers or features, whilst of possible benefit in some embodiments of the invention, may not be desirable, and may therefore be absent, in other embodiments.

While the invention has been described in conjunction with the exemplary embodiments described above, many equivalent modifications and variations will be apparent to those skilled in the art when given this disclosure. Accordingly, the exemplary embodiments of the invention set forth above are considered to be illustrative and not limiting. Various changes to the described embodiments may be made without departing from the spirit and scope of the invention.

For the avoidance of any doubt, any theoretical explanations provided herein are provided for the purposes of improving the understanding of a reader. The inventors do not wish to be bound by any of these theoretical explanations.

Any section headings used herein are for organisational purposes only and are not to be construed as limiting the subject matter described.

Throughout this specification, including the claims which follow, unless the context requires otherwise, the word “comprise” and “include”, and variations such as “comprises”, “comprising” and “including”, will be understood to imply the inclusion of a stated integer or step or group of integers or steps but not the exclusion of any other integer or step or group of integers or steps.

It must be noted that, as used in the specification and the appended claims, the singular forms “a”, “an” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by the use of the antecedent “about”, it will be understood that the particular value forms another embodiment. The term “about” in relation to a numerical value is optional and means for example +/— 10%.

1. A method of removing one or more aldehydes from a carrier fluid comprising ambient air, the method comprising the step of:
contacting the carrier fluid comprising one or more aldehydes with a catalyst comprising manganese oxide.

2. The method of claim 1 wherein the catalyst comprises manganese IV oxide and/or cryptomelane.

3. The method of claim 1 wherein at least one aldehyde comprises at least two carbon atoms.

4-5. (canceled)

6. The method of claim 1 wherein the catalyst comprises a support on or in which the manganese IV oxide and/or cryptomelane is supported.

7. The method of claim 6 wherein the support comprises a foam and/or a metal support and/or a ceramic support.

8. The method according to claim 6 wherein the catalyst comprises at least 10 wt % support, and up to 90 wt % support.

9. The method according to claim 1 wherein the catalyst comprises a binder.

10. The method according to claim 9 wherein the catalyst comprises up to 60 wt % binder.

11. The method of claim 1 wherein the carrier fluid consists essentially of ambient air.

12. The method of claim 1 comprising contacting the carrier fluid with the catalyst at a temperature of at least 10° C.

13-16. (canceled)

17. The method of claim 1 comprising contacting a flow of the carrier fluid with the catalyst, the flow rate of the carrier fluid being configured to provide a reduction in the aldehyde content of the carrier fluid of at least 30%.

18. The method of claim 1 wherein the carrier fluid comprises at least 1 ppb one or more aldehydes.

19. The method of claim 1 comprising contacting the carrier fluid with the catalyst at a pressure less than ambient pressure.

20. The method of claim 1 further comprising the step of:
facilitating removal from the carrier fluid of one or more impurities before the step of contacting with the catalyst.

21. The method of claim 20 wherein the step of facilitating removal from the carrier fluid of one or more impurities comprises filtering the carrier fluid.

22. The method of claim 1 claim further comprising the step of:
heating the catalyst to a regeneration temperature of at least 90° C. in the presence of a source of oxygen.

23. The method of claim 22, wherein the step of heating the catalyst to the regeneration temperature is before the step of contacting with the catalyst.

24-26. (canceled)

27. The method of claim 22 wherein the step of heating the catalyst to the regeneration temperature is carried out for at least 15 minutes.

28.-31. (canceled)

32. The method of claim 22 wherein the length of time of carrying out the step of contacting with the catalyst is at most 30 times the length of time of the step of heating the catalyst to the regeneration temperature.

33.-36. (canceled)

37. A method comprising removing one or more aldehydes from a carrier fluid comprising ambient air using a catalyst comprising manganese oxide.

38. The method of claim 37 wherein the catalyst comprises manganese IV oxide and/or cryptomelane.

39. The method of claim 37 wherein at least one aldehyde comprises at least two carbon atoms.
